(19) United States
(12) Patent Application Publication
(10) Pub. No.: US 2015/0138578 A1
(43) Pub. Date: May 21, 2015

(54) PRINTING APPARATUS, CONTROL METHOD THEREFOR, AND STORAGE MEDIUM

(71) Applicant: CANON KABUSHIKI KAISHA, Tokyo (JP)

(72) Inventor: Masaki Kashiwagi, Hiratsuka-shi (JP)

(21) Appl. No.: 14/539,692

(22) Filed: Nov. 12, 2014

(30) Foreign Application Priority Data
Nov. 21, 2013 (JP) 2013-241269

(51) Int. Cl. H04N 1/00; B65H 43/00; G06K 15/16; B65H 37/04

(52) U.S. Cl. CPC H04N 1/00639; B65H 37/04; B65H 43/00; G06K 15/16; H04N 1/00644; H04N 1/00591; H04N 2201/0094; H04N 2201/0082
USPC 358/1.12

(57) ABSTRACT

There is provided a technique that enables a user to use a post-processing apparatus without giving a mode changing instruction after execution of a print job including post-processing by the post-processing apparatus has ended in a printing apparatus. Specifically, during execution of a print job in which the execution of post-processing on a sheet is set, the printing apparatus determines whether or not the post-processing apparatus has discharged a sheet on which printing processing has been performed, without executing the post-processing. If it is determined that the post-processing apparatus has discharged the sheet on which printing processing has been performed, without executing the post-processing, the printing apparatus changes the post-processing apparatus to a manual stapling (MS) mode.

### BACKGROUND OF THE INVENTION

1. Field of the Invention

The present invention relates to a printing apparatus such as a printer or a digital multifunction peripheral, a control method therefor, and a storage medium.

2. Description of the Related Art

In general, an image forming apparatus (printing apparatus) connected to a post-processing apparatus that performs post-processing such as stapling processing forms an image on a recording sheet, and thereafter conveys the recording sheet from the image forming apparatus to the post-processing apparatus. Then, the image forming apparatus causes the post-processing apparatus to execute post-processing on the recording sheet. For example, with the post-processing apparatus that executes stapling processing, stapling processing is executed on a bundle of sheets that has been conveyed from the image forming apparatus and stacked on a tray.

Meanwhile, there are post-processing apparatuses that perform post-processing on sheets that are directly set by the user, rather than the sheets conveyed from the image forming apparatus. For example, Japanese Patent Laid-Open No. 2005-206298 proposes a post-processing apparatus that performs stapling processing on a bundle of sheets that is directly set on a processing tray (hereinafter, such stapling processing is referred to as “manual stapling”). In addition, Japanese Patent Laid-Open No. 2005-107322 proposes a post-processing apparatus that is switchable between a first mode in which stapling processing is automatically executed when a bundle of sheets inserted in a sheet storage portion is detected by a sensor, and a second mode in which stapling processing is executed in accordance with a predetermined switch operation.

The image forming apparatus connected to the post-processing apparatus is shifted to a manual stapling mode in accordance with a user instruction. During execution of manual stapling in the post-processing apparatus, the image forming apparatus performs control to stop the execution of image formation. In addition, the post-processing apparatus performs control not to execute manual stapling during execution of image formation in the image forming apparatus. This control makes it possible to prevent the occurrence, in the post-processing apparatus, of a jam resulting from collision between a sheet on which an image has been formed by the image forming apparatus and conveyed to the post-processing apparatus and a sheet on which manual stapling is to be executed in the post-processing apparatus.

In an image forming apparatus (printing apparatus) as described above, a sheet on which printing processing has been performed may be discharged without being subjected to post-processing in the post-processing apparatus although a print job in which post-processing such as stapling processing is set has been executed. For example, in a conventional printing apparatus, when sheets that are long in the conveyance direction, such as size A3 sheets, are used, the sheets may protrude from an intermediate tray (stack tray) on which sheets are stacked for stapling processing. In that case, the weight of the protruding portion of the sheets causes the sheets to be displaced, making it impossible to execute stapling processing in a stable manner. To avoid the occurrence of this condition, a limit (upper limit) is set for the number of sheets on which stapling processing can be executed, and control is performed to discharge the sheets in excess of the limit, without executing stapling processing on these sheets.

Thus, if a sheet is discharged without stapling processing executed thereon although the user has set the execution of stapling processing in the print job, the user can perform stapling processing on the discharged sheet by using manual stapling. However, after the sheet is discharged, the user cannot shift the printing apparatus to the manual stapling mode unless the user gives an instruction to shift to manual stapling. Accordingly, once the execution of a subsequent job had been started, the user cannot use manual stapling until the execution of the subsequent job ends.

### SUMMARY OF THE INVENTION

The present invention has been made in view of the above-described problem. The present invention provides a technique for enabling the user to use a post-processing apparatus without giving a mode changing instruction after the execution of a print job including post-processing by the post-processing apparatus has ended in a printing apparatus.

According to one aspect of the present invention, there is provided a printing apparatus comprising: a printing unit configured to print an image on a sheet; a conveyance unit configured to convey the sheet on which printing has been performed by the printing unit to a post-processing apparatus; a post-processing unit configured to cause the post-processing apparatus to execute post-processing on the sheet conveyed by the conveyance unit or a sheet set by a user; and a changing unit configured to change the printing apparatus to a mode that permits execution of the post-processing on a sheet that has been set in the post-processing apparatus by the user, in response to having been unable to execute the post-processing by the post-processing apparatus although the post-processing is set for the sheet conveyed by the conveyance unit.

According to another aspect of the present invention, there is provided a printing apparatus comprising: a printing unit configured to print an image on a sheet; a conveyance unit configured to convey the sheet on which the image is printed by the printing unit to a post-processing apparatus; a post-processing unit configured to cause the post-processing apparatus to execute post-processing on the sheet conveyed by the conveyance unit; and a limitation unit configured to limit printing of an image by the printing unit on the sheet conveyed by the conveyance unit, in response to having been unable to execute the post-processing by the post-processing apparatus.

According to still another aspect of the present invention, there is provided a control method for controlling a printing apparatus, the method comprising steps of: printing an image on a sheet; conveying the sheet on which printing has been performed in the printing step to a post-processing apparatus; causing the post-processing apparatus to execute post-processing on the sheet conveyed in the conveying step or a sheet set by a user; and changing the printing apparatus to a mode that permits execution of the post-processing on a sheet that has been set in the post-processing apparatus by the user, in response to having been unable to execute the post-processing by the post-processing apparatus although the post-processing is set for the sheet conveyed in the conveying step.

According to still another aspect of the present invention, there is provided a computer-readable storage medium storing a computer program for causing a computer to execute steps of a control method for controlling a printing apparatus, the method comprising steps of: printing an image on a sheet; conveying the sheet on which printing has been performed in the printing step to a post-processing apparatus; causing the post-processing apparatus to execute post-processing on the sheet conveyed in the conveying step or a sheet set by a user; and changing the printing apparatus to a mode that permits execution of the post-processing on a sheet that has been set in the post-processing apparatus by the user, in response to having been unable to execute the post-processing by the post-processing apparatus although the post-processing is set for the sheet conveyed in the conveying step.

The present invention can enable the user to use a post-processing apparatus without giving an instruction to change the mode after the execution of a print job including post-processing by a post-processing apparatus has ended in a printing apparatus. This can further improve the user convenience.

Further features of the present invention will become apparent from the following description of exemplary embodiments (with reference to the attached drawings).

### BRIEF DESCRIPTION OF THE DRAWINGS

FIG. 1 is a block diagram showing a configuration of an image forming apparatus.

FIG. 2 is a cross-sectional view showing a configuration of the image forming apparatus and a post-processing apparatus.

FIG. 3 is an external view of the post-processing apparatus.

FIGS. 4A and 4B are diagrams each showing an example of a screen displayed in an operation unit.

FIGS. 5A and 5B are flowcharts showing a procedure of print control in the image forming apparatus based on a print job in which the execution of stapling processing is set.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

(System Configuration)

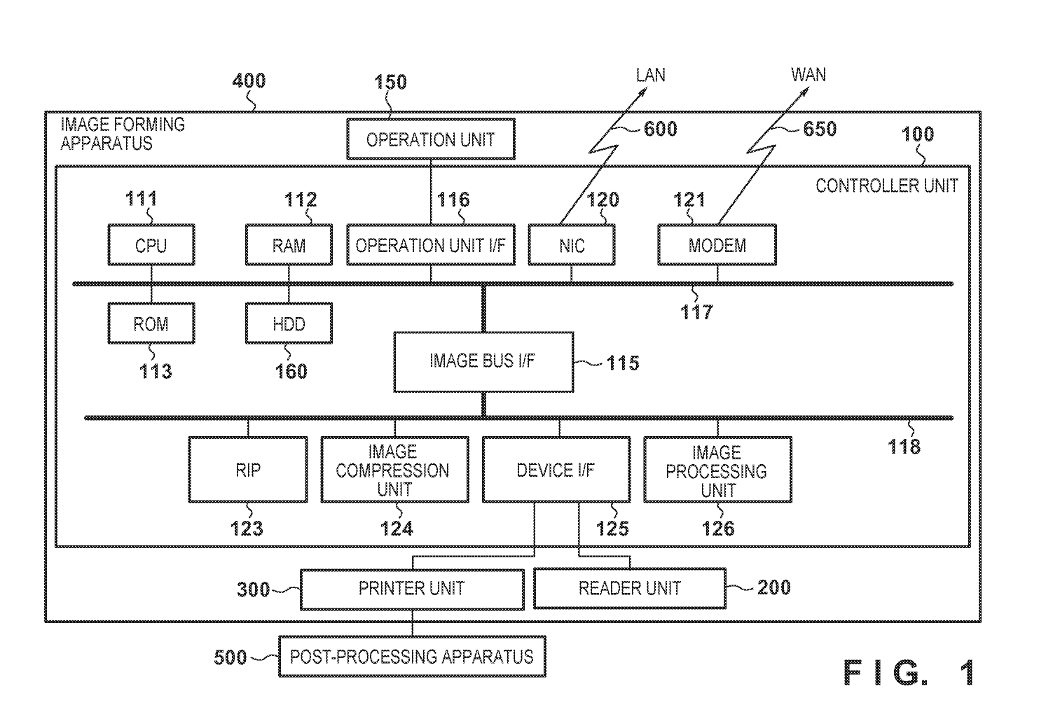

First, with reference to FIGS. 1 to 3, a description will be given of the configuration of a printing system according to the present embodiment that includes an image forming apparatus and a post-processing apparatus. In the present embodiment, an image forming apparatus (printing apparatus) to which a post-processing apparatus is externally connected will be described as an application example of the present invention. However, the present invention is also applicable to an image forming apparatus (printing apparatus) incorporating a post-processing apparatus.

FIG. 1 is a block diagram showing an exemplary configuration of an image forming apparatus according to the present embodiment. The image forming apparatus 400 includes a controller unit 100, and an operation unit 150, a reader unit 200, and a printer unit 300 that are connected to the controller unit 100. The controller unit 100 controls each of the operation unit 150, the reader unit 200, and the printer unit 300, and also controls a post-processing apparatus 500 via the printer unit 300. The image forming apparatus 400 is capable of communicating with an external apparatus such as an external host computer via a LAN 600 or a WAN (public network) 650.

To the printer unit 300 (image forming apparatus 400), the post-processing apparatus 500 is connected that performs post-processing such as sorting processing, folding processing, bookbinding processing, punching processing, and stapling processing on a recording sheet (sheet) on which image forming (printing) processing has been performed. The present embodiment is described, taking as an example a case where the post-processing apparatus 500 is a stapler that performs stapling processing on the sheet as post-processing. However, the present invention can also be implemented in the same manner as in the present embodiment when the post-processing apparatus 500 is an apparatus that performs post-processing other than stapling processing, such as folding processing and punching processing.

The reader unit 200 is an image input device that performs reading processing for optically reading an image of a document to generate image data. The image data generated by the reader unit 200 and image data received from an external apparatus via the LAN 600 or the WAN 650 can be stored in a HDD (hard disk drive) within the controller unit 100. The printer unit 300 is an image output device that performs output (printing) processing for forming (printing) an image on a sheet based on the image data generated by the reader unit 200 and the image data received from the external apparatus via the LAN 600 or the WAN 650. The operation unit 150 includes a liquid crystal panel for performing displaying relating to various types of information and functions, and a keyboard and a touch panel for accepting an operational input made by the user.

The controller unit 100 provides a copy function, for example, by controlling the reader unit 200 to read an image of a document to generate image data, and controlling the printer unit 300 to print an image based on the image data on a sheet. The controller unit 100 also provides a scanner function of converting image data generated by the reader unit 200 into code data and transmitting the code data to the external apparatus. Furthermore, the controller unit 100 provides a printer function of converting code data received from the external apparatus into image data and outputting the image data to the printer unit 300, thereby printing an image based on the image data on a sheet.

The controller unit 100 includes a CPU 111, a RAM 112, a ROM 113, a HDD 160, an operation unit I/F (interface) 116, a NIC (network interface card) 120, a modem 121, and an image bus I/F 115. These devices are mutually connected via a system bus 117.

The CPU 111 controls the devices included in the image forming apparatus 400 to realize various functions in the image forming apparatus 400, by reading out a program stored in the ROM 113 or the HDD 160 onto the RAM 112 and executing the program. The RAM 112 is a system work memory for enabling the CPU 111 to operate, and is also used as an image memory in which data such as image data is temporarily stored. The ROM 113 functions as a boot ROM, in which a system boot program is stored.

The HDD 160 can store data relating to jobs such as a print job, system software, image data, and the like. The operation unit I/F 116 functions as an interface to the operation unit 150. The operation unit I/F 116 outputs, to the operation unit 150, image data for displaying a screen on the operation unit 150, and transfers, to the CPU 111, information that has been input by the user through an operation using the operation unit 150. The NIC 120 is connected to the LAN 600, and transmits and receives the image data, device information, and the like to and from an external apparatus connected via the LAN 600, in accordance with an instruction from the CPU 111. The modem 121 is connected to the WAN 650, and transmits and receives the image data, device information, and the like to and from an external apparatus connected via the WAN 650, in accordance with an instruction from the CPU 111.

The image bus I/F 115 is an interface that connects the system bus 117 and an image bus 118 capable of high-speed image data transfer, and functions as a bus bridge that converts the structure of the data transferred between these buses. The image bus 118 is constituted by a PCI bus or an IEEE 1394. To the image bus 118, a RIP (raster image processor) 123, an image compression unit 124, a device I/F 125, and an image processing unit 126 are connected.

The RIP 123 renders a PDL code into a bitmap image. The image compression unit 124 performs JPEG compression/decompression processing on multivalued image data, and JBIG, MMR, or MH compression/decompression processing on binary image data. The device I/F 125 is an interface that connects the reader unit 200 and the printer unit 300 to the controller unit 100, and performs synchronous/asynchronous conversion of image data. The image processing unit 126 performs correction, processing, and editing on the image data (input image data) generated by the reader unit 200.

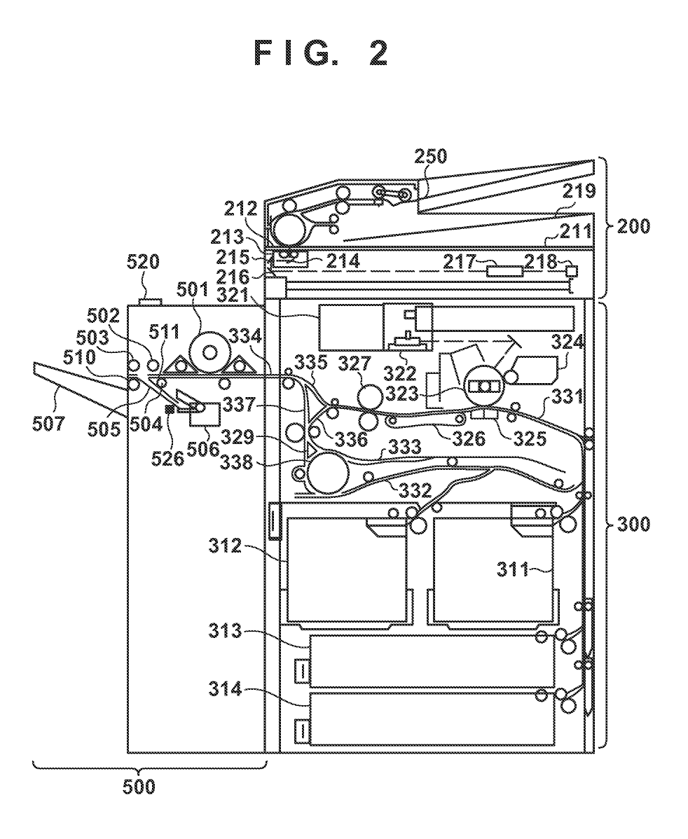

Next, a description will be given of a specific configuration and operation of the image forming apparatus 400 and the post-processing apparatus 500 with reference to FIG. 2. FIG. 2 is a cross-sectional view of the image forming apparatus 400 and the post-processing apparatus 500.

(Reader Unit 200)

In the reader unit 200, a document feed (DF) unit 250 sequentially conveys stacked documents onto a platen glass 211 one at a time, and discharges the documents on the platen glass 211 to a discharge tray 219 after the document reading operation ends. When a document is conveyed onto the platen glass 211, a lamp 212 is turned on and an optical unit 213 starts moving, so that the document is exposed and scanned. The light reflected from the document is guided to a CCD image sensor 218 by mirrors 214, 215 and 216, and a lens 217. An image of the document is thus read by the CCD image sensor 218. The image data output from the CCD image sensor 218 is subjected to predetermined processing, and thereafter transferred to the controller unit 100.

(Printer Unit 300)

In the printer unit 300, a laser driver 321 drives a laser emitting unit 322 so as to output, from the laser emitting unit 322, laser light corresponding to the image data output from the controller unit 100. As a result of this laser light being applied to a photosensitive drum 323, an electrostatic latent image corresponding to the laser light is formed on the photosensitive drum 323. A developing material (e.g., toner) supplied from a developer 324 adheres onto the electrostatic latent image portion of the photosensitive drum 323. The printer unit 300 includes, as paper feed units, cassettes 311 to 314 each having the shape of a drawer, and recording sheets (sheets) are supplied to the cassettes by the user.

The printer unit 300 feeds a sheet from one of the cassettes 311 to 314, and conveys the sheet to a transfer unit 325 via a conveyance path 331. The transfer unit 325 transfers the developing material adhering to the photosensitive drum 323 onto the sheet. The sheet onto which the developing material has been transferred is conveyed by a conveyance belt 326 to a fixing unit 327. The fixing unit 327 fixes the developing material onto the sheet by using heat and pressure. The sheet that has passed through the fixing unit 327 passes through conveyance paths 335 and 334, and is discharged to the outside of the image forming apparatus 400.

In the case of discharging a sheet to the outside with its print surface inverted, the printer unit 300 guides the sheet to conveyance paths 336 and 338, from where the sheet is conveyed in the opposite direction and passed through conveyance paths 337 and 334. In the case of performing double-side printing, the printer unit 300 guides the sheet from the conveyance path 336 to a conveyance path 333 by using a flapper 329 after the sheet has passed through the fixing unit 327. Furthermore, the printer unit 300 conveys the sheet in the opposite direction, and guides the sheet to the conveyance path 338 and a re-feeding conveyance path 332 by using the flapper 329. The sheet that has been guided to the re-feeding conveyance path 332 passes through the conveyance path 331, and is fed to the transfer unit 325 again. Note that regardless of which of single-sided printing and double-side printing is performed, the sheet discharged from the conveyance path 334 is conveyed to the post-processing apparatus 500.

(Post-Processing Apparatus 500)

The sheet that has been conveyed to the post-processing apparatus 500 is first sent to a buffer unit 501. In the buffer unit 501, the conveyed sheet is buffered by winding the sheet around a buffer roller, as needed. For example, if stapling processing performed downstream the buffer unit 501 takes time, the sheet conveyed from the image forming apparatus 400 is buffered in the buffer unit 501. This allows the sheet conveyance speed to be maintained constant, thus improving the throughput.

In the case of not performing stapling processing, the sheet conveyed from the buffer unit 501 is discharged by an upstream discharge roller pair 502 and a downstream discharge roller pair 503 to a discharge tray 507 through a conveyance path 511. On the other hand, in the case of performing stapling processing, the sheet conveyed from the buffer unit 501 is conveyed by the upstream discharge roller pair 502. Immediately after the rear edge of the sheet has passed through that roller pair, the sheet is pulled back by a knurling belt 504, and stacked on a stack tray 505. Thereafter, when a predetermined number of sheets have been stacked on the stack tray 505, stapling processing is performed on the sheets by a stapling unit 506. The sheets on which stapling processing has been performed are discharged to the discharge tray 507 by the downstream discharge roller pair 503. Note that the post-processing apparatus 500 can also perform shift sorting by discharging the sheets stacked on the stack tray 505 to the discharge tray 507, while laterally shifting the sheets.

In the present embodiment, the post-processing apparatus 500 has two operation modes, namely, an automatic stapling mode (first mode) and a manual stapling mode (second mode). Normally, the post-processing apparatus 500 operates in the automatic stapling mode. In the automatic stapling mode, the post-processing apparatus 500 stacks, on the stack tray 505, sheets on which printing processing has been performed, and which are discharged (conveyed) from the image forming apparatus 400 through the conveyance path 334. Thereafter, the post-processing apparatus 500 executes post-processing (stapling processing) on the stacked sheets. On the other hand, in the manual stapling mode, the post-processing apparatus 500 executes post-processing (stapling processing) on sheets that have been set in the post-processing apparatus 500 (i.e., the stack tray 505) by the user. In this case, when the user inserts a bundle of sheets into the stack tray 505, a sheet bundle detection sensor 526 detects the bundle of sheets. In response to this, the stapling unit 506 performs stapling processing on the bundle of sheets set in the stack tray 505.

Note that the post-processing apparatus 500 is changed from the automatic stapling mode to the manual stapling mode in accordance with the pressing of a manual stapling mode button 520, or an instruction from the controller unit 100. However, when the image forming apparatus 400 is executing printing processing, the post-processing apparatus 500 will not be shifted to the manual stapling mode even if the manual stapling mode button 520 is pressed.

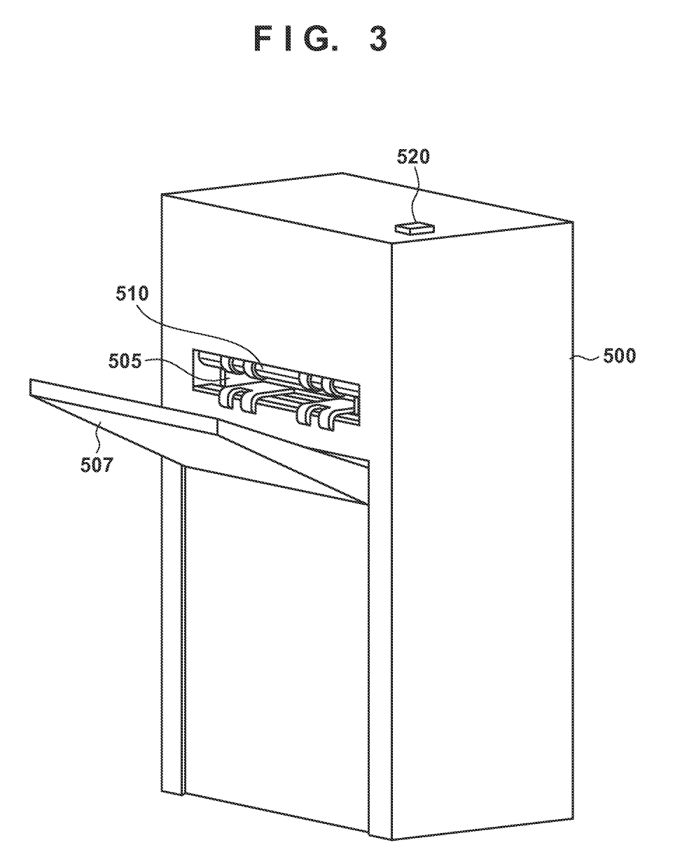

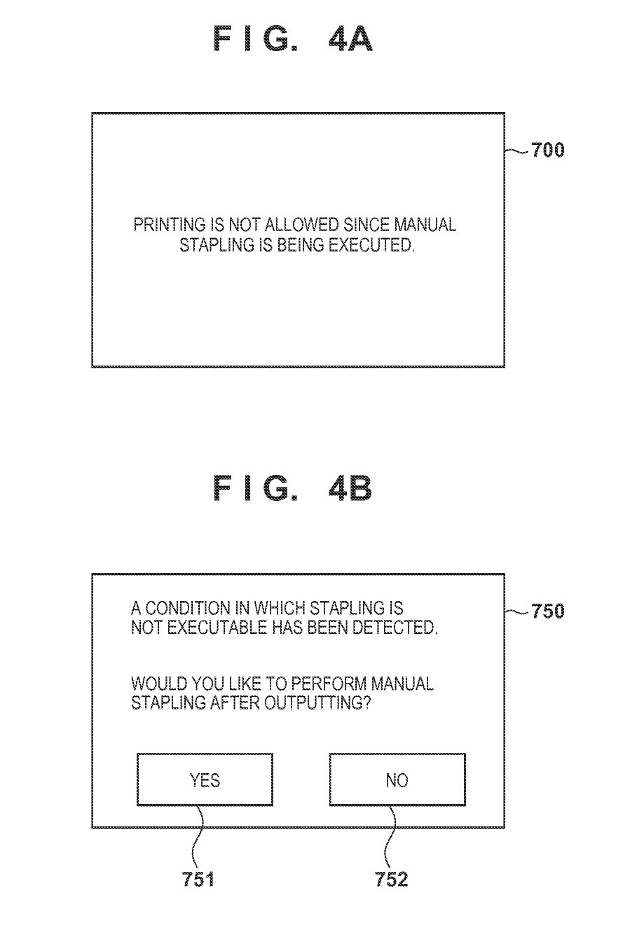

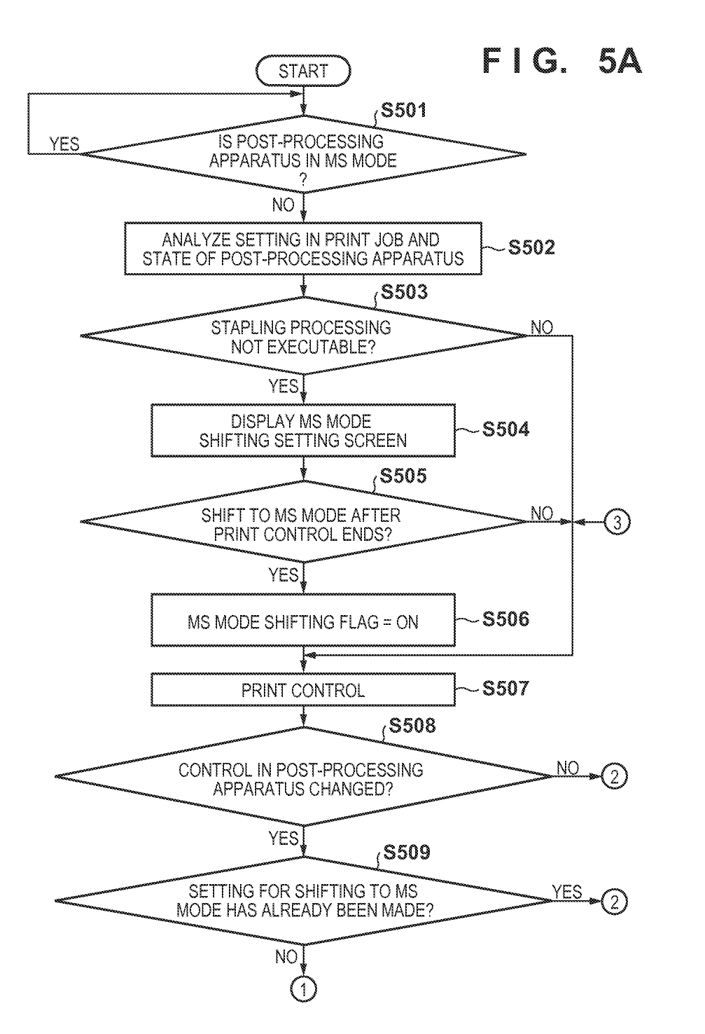

Next, an operation of the post-processing apparatus 500 in the manual stapling mode will be described with reference to FIGS. 3 and 4. FIG. 3 is an external view of the post-processing apparatus 500. First, when the user presses the manual stapling mode button 520 of the post-processing apparatus 500, the post-processing apparatus 500 is shifted from the automatic stapling mode to the manual stapling mode if the image forming apparatus 400 is not executing printing processing. Thereafter, the user inserts a bundle of sheets to be subjected to stapling processing into the stack tray 505 from a discharging port 510, thereby setting the bundle of sheets in the post-processing apparatus 500. Inside the post-processing apparatus 500, the sheet bundle detection sensor 526 for detecting the insertion of the bundle of sheets onto the stack tray 505 is provided. When the sheet bundle detection sensor 526 detects the bundle of sheets, the stapling unit 506 performs stapling processing on the bundle of sheets on the stack tray 505.

On the other hand, if the image forming apparatus 400 is executing printing processing, the post-processing apparatus 500 ignores the pressing of the manual stapling mode button 520. The reason is that if the image forming apparatus 400 is executing printing processing, the sheets having undergone printing processing, which have been conveyed from the image forming apparatus 400, are discharged from the discharging port 510 and collide with the bundle of sheets for manual stapling. Note that if the image forming apparatus 400 is not executing printing processing, the sheets having undergone printing processing will not be discharged from the discharging port 510, and therefore, the user can monopolize the post-processing apparatus 500 for manual stapling.

When the post-processing apparatus 500 has been shifted to the manual stapling mode as a result of the manual stapling mode button 520 being pressed, the controller unit 100 displays a screen 700 as shown in FIG. 4A. The controller unit 100 displays the screen 700, which indicates that printing processing cannot be executed since manual stapling is being executed in the post-processing apparatus 500, in the operation unit 150, thereby making it possible to explicitly inform the user of that information.

The post-processing apparatus 500 is returned to the automatic stapling mode from the manual stapling mode in the following cases. For example, the post-processing apparatus 500 is returned to the automatic stapling mode (1) automatically at the end of the execution of manual stapling, (2) when the manual stapling mode button 520 is pressed, or (3) when a preset timeout period has elapsed. Additionally, by operating the operation unit 150 of the image forming apparatus 400, the user can specify in which of the aforementioned cases the post-processing apparatus 500 is to be returned to the automatic stapling mode from the manual stapling mode.

(Print Control in Image Forming Apparatus)

Upon receiving a print job in which the execution of post-processing on sheets is set, the image forming apparatus 400 causes the post-processing apparatus 500 to execute post-processing on sheets on which printing processing according to the setting included in the print job has been executed. However, as described above, a condition may occur in which the sheets having undergone printing processing are directly discharged without the execution of the set post-processing although the user has set the execution of post-processing in the print job.

For example, when the post-processing apparatus 500 executes stapling processing as post-processing, there is a limit for the number of sheets on which stapling processing is executable according to the type or size of sheets used for a print job, depending on the performance of the post-processing apparatus 500. This performance of the post-processing apparatus 500 includes, for example, the force generated by the stapling unit 506, the length of the staples used for stapling processing, and the stacking capacity of the stack tray 505. When the number of sheets exceeds the above-described limit while automatically executing stapling processing on the sheets conveyed from the image forming apparatus 400, the post-processing apparatus 500 performs control to discharge the sheets that are subsequently conveyed without performing stapling processing thereon. The post-processing apparatus 500 also performs the same control when there is no remaining staple used for stapling processing while executing stapling processing on the sheets conveyed from the image forming apparatus 400. Thus, a condition may occur in which the control in the post-processing apparatus 500 is automatically changed to another control that is different from the control in accordance with the setting in a print job, during execution of the print job.

Further, when a setting that is inhibited to be combined with post-processing executed in the post-processing apparatus 500 is included in the print job received by the image forming apparatus 400, control to inhibit the execution of post-processing in the post-processing apparatus 500 may be performed. For example, in the case of performing printing processing on a sheet having a large length or a user defined size, there is the possibility that stapling processing cannot be normally executed by the stapling unit 506, depending on the stacking capacity of the stack tray 505. For this reason, the execution of stapling processing is inhibited if such a sheet is set in a print job. Alternatively, in the case of performing mirror image printing, the recognition of orientation of the discharged sheets may vary from one user to another. Accordingly, if stapling processing is performed on a sheet on which mirror image printing has been performed, there is the possibility that the position at which stapling processing is performed in the sheet may be different from the position intended by the user. Therefore, when the execution of mirror image printing is set in a print job, the execution of stapling processing is inhibited. Thus, depending on the setting included in a print job, a condition may occur in which the control in the post-processing apparatus 500 is automatically changed to another control that is different from the control in accordance with the setting in the print job.

As described above, in the case where the control in the post-processing apparatus 500 is automatically changed and a sheet is discharged without execution of post-processing, it is possible to obtain a sheet on which post-processing has been performed by manually executing post-processing (manual stapling) on that sheet. However, in the case where the execution of a subsequent job is started immediately after the sheet has been discharged, the user needs to wait until that job ends, and thus cannot immediately use manual stapling. Accordingly, in such a case, it is desirable that the user can use manual stapling before the execution of the subsequent job is started.

The present embodiment provides a mechanism that enables the user to continuously use the post-processing apparatus 500 without being hindered by a subsequent print job, after the execution of a print job including post-processing (stapling processing) by the post-processing apparatus 500 has ended. Specifically, upon receiving a print job in which the execution of post-processing on a sheet is set, the image forming apparatus 400 sets the post-processing apparatus 500 in the automatic stapling mode, and executes the print job. Furthermore, the image forming apparatus 400 determines whether a condition has occurred in which the post-processing apparatus 500 discharges a sheet on which printing processing has been performed without executing post-processing on the sheet during execution of a print job. If it is determined that this condition has occurred, the image forming apparatus 400 shifts the post-processing apparatus 500 from the automatic stapling mode to the manual stapling mode after the end of the execution of the print job and before the start of the execution of the next print job. This processing enables the user to use manual stapling without the need to provide a mode shifting instruction in post-processing apparatus 500 after the execution of the print job ends, without being hindered by the next print job.

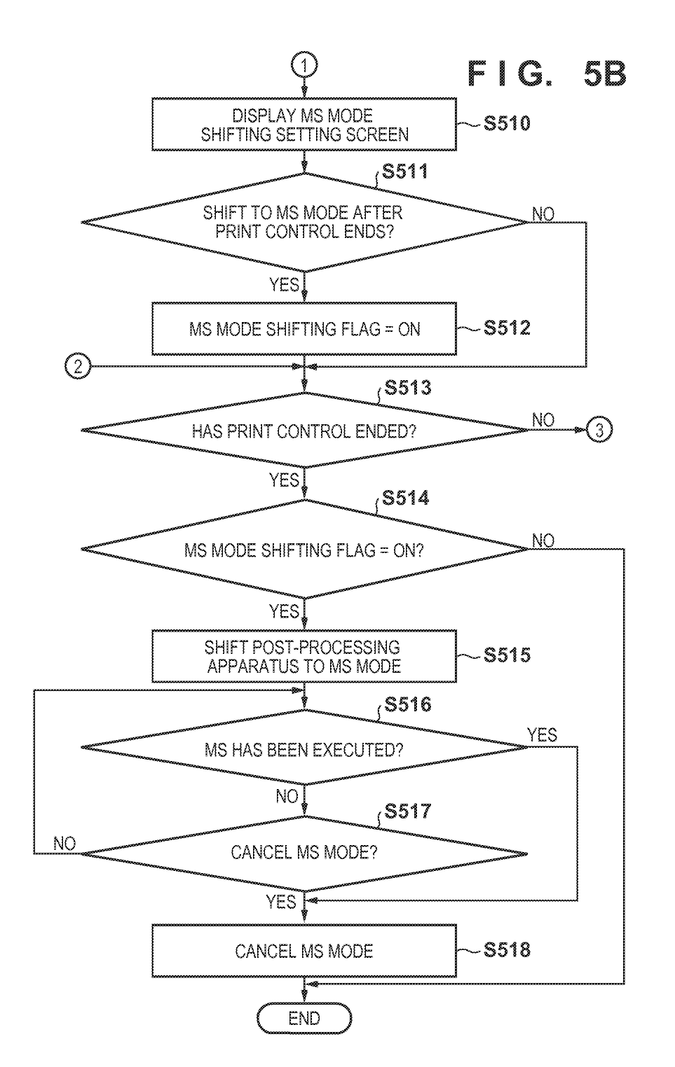

In the following, a specific example of the print control performed in the image forming apparatus 400 according to the present embodiment will be described with reference to FIGS. 5A and 5B. This print control is based on a print job in which the execution of stapling processing is set. FIGS. 5A and 5B are flowcharts illustrating the procedure of the print control in the image forming apparatus 400 according to the present embodiment. The processing in the steps in the flowchart shown in FIGS. 5A and 5B is realized in the image forming apparatus 400 by the CPU 111 reading out a program stored in the ROM 113 or the HDD 160 onto the RAM 112 and executing the program.

First, upon receiving a print job from an external apparatus via the LAN 600 or the WAN 650, the CPU 111 starts the processing of step S501. In this print job, it is set that stapling processing should be executed as post-processing on a bundle of sheets on which printing processing has been performed. Note that the print job may be generated based on a user operation using the operation unit 150 when the user uses the copy function of the image forming apparatus 400, and may be received by the CPU 111.

In step S501, the CPU 111 determines whether or not the post-processing apparatus 500 is in the manual stapling (hereinafter, also referred to as “MS”) mode. If it is determined in step S501 that the post-processing apparatus 500 is in the MS mode, the CPU 111 waits until the MS mode is cancelled and the post-processing apparatus 500 is shifted to the automatic stapling (hereinafter, also referred to as “AS”) mode, by repeating the determination processing of step S501. Note that while the post-processing apparatus 500 is in the MS mode, the screen 700 as shown in FIG. 4A may be displayed in the operation unit 150. On the other hand, if it is determined in step S501 that the post-processing apparatus 500 is not in the MS mode (i.e., is in the AS mode), the CPU 111 advances the processing to step S502. Thus, the CPU 111 starts the processing (execution) of the print job in a state in which the post-processing apparatus 500 is set in the AS mode.

In step S502, the CPU 111 analyzes the setting in the print job and the state of the post-processing apparatus 500. Furthermore, the CPU 111 determines in step S503 whether or not stapling processing in the post-processing apparatus 500 can be executed, based on the result of analysis of the setting in the print job and the state of the post-processing apparatus 500. Specifically, the CPU 111 determines that stapling processing is not executable if a predetermined setting is included in the print job or if the post-processing apparatus 500 is in the state in which there is no staple to be used for stapling processing. Otherwise, the CPU 111 determines that the stapling processing is executable. Here, the predetermined setting is a setting that is inhibited to be combined with stapling processing in the post-processing apparatus 500 as described above.

In step S503, if it is determined that stapling processing is executable in the post-processing apparatus 500, the CPU 111 advances the processing to step S507. If it is determined that stapling processing is not executable, the CPU 111 advances the processing to step S504. In step S504, the CPU 111 displays an MS mode shifting setting screen 750 as shown in FIG. 4B in the operation unit 150. With the MS mode shifting setting screen 750, it is possible to set whether or not to shift the post-processing apparatus 500 from the AS mode to the MS mode after the end of execution of the print job and prior to the start of execution of the next print job.

Next, in step S505, the CPU 111 determines whether or not to shift the post-processing apparatus 500 to the MS mode after the print job (print control) ends. If the user presses the button 751 by using the operation unit 150, the CPU 111 determines to shift the post-processing apparatus 500 to the MS mode after the print job ends, and advances the processing to step S506. On the other hand, if the user presses the button 752, the CPU 111 determines not to shift the post-processing apparatus 500 to the MS mode after the print job ends, and advances the processing to step S507. In step S506, the CPU 111 sets a MS mode shifting flag, which indicates whether or not to shift the post-processing apparatus 500 to the MS mode after the print job ends, to ON, and advances the processing to step S507. Note that the MS mode shifting flag is set to OFF in advance in step S502.

In step S507, the CPU 111 starts the print control based on the print job. Specifically, the CPU 111 performs printing processing on sheets by using the printer unit 300, conveys the sheets on which printing processing has been performed from the printer unit 300 to the post-processing apparatus 500, and stacks the sheets in the post-processing apparatus 500. The post-processing apparatus 500 automatically executes stapling processing on a bundle of the stacked sheets. However, if it is determined that the stapling processing in the post-processing apparatus 500 is not executable (in step S503), the CPU 111 controls the post-processing apparatus 500 so as to discharge the bundle of sheets conveyed from the image forming apparatus 400 without executing stapling processing thereon.

If the number of the sheets on which printing processing has been performed in accordance with the print job exceeds the predetermined limit during execution of the print job, the post-processing apparatus 500 discharges sheets that are subsequently conveyed from the image forming apparatus 400 without performing stapling processing thereon. As described above, this limit may be predetermined based on the type or size of the sheets used for the print job and the performance of the post-processing apparatus 500. At the time of starting such control, the post-processing apparatus 500 notifies the image forming apparatus 400 (CPU 111) of the fact that a condition has occurred in which the sheets are discharged without performing thereon stapling processing in the post-processing apparatus 500.

In step S508, the CPU 111 determines whether a condition has occurred in which the post-processing apparatus 500 discharges the sheets without executing stapling processing thereon, based on the notification from the post-processing apparatus 500. That is, the CPU 111 determines whether or not the control in the post-processing apparatus 500 has been automatically changed to another control that is different from the control in accordance with the setting in the print job. If it is determined that the control in the post-processing apparatus 500 has been changed, the CPU 111 advances the processing to step S509. If it is determined that the control has not been changed, the CPU 111 advances the processing to step S513. In S509, the CPU 111 determines whether or not the MS mode shifting setting screen 750 was displayed in the operation unit 150 and a setting relating to the shift to the MS mode has already been made. If it is determined that the setting relating to the shift to the MS mode has not yet been made, the CPU 111 advances the processing to step S510. If it is determined that the setting has already been made, the CPU 111 advances the processing to step S513.

The processing in steps S510 to S512 is the same as the processing in step S504 to S506. If it is determined in step S511 not to shift the post-processing apparatus 500 to the MS mode after the print job ends, the CPU 111 advances the processing to step S513. Alternatively, if the CPU 111 determines in step S511 to shift the post-processing apparatus 500 to the MS mode after the print job ends and sets the MS mode shifting flag to ON in step S512, it advances the processing to step S513.

In step S513, the CPU 111 determines whether or not the print control in accordance with the print job has ended. If it is determined that the print control has not ended, the CPU 111 returns the processing to step S507, thereby continuing the print control. On the other hand, if it is determined that the print control has ended, the CPU 111 ends the execution of the print job, and advances the processing to step S514. In step S514, the CPU 111 determines whether or not the MS mode shifting flag is ON. If it is not ON, the CPU 111 ends the processing. If it is ON, the CPU 111 advances the processing to step S515.

In step S515, the CPU 111 shifts the post-processing apparatus 500 from the AS mode to the MS mode. Thus, if a condition in which the post-processing apparatus 500 discharges the sheets without executing stapling processing has occurred, the CPU 111 shifts the post-processing apparatus 500 from the AS mode to the MS mode after the end of execution of the print job and before the start of the execution of the next print job. Further, the CPU 111 puts the execution of printing processing in the printer unit 300 in the stopped state. The CPU 111 may further display the screen 700 as shown in FIG. 4 in the operation unit 150. Thus, it is possible to inform the user that printing processing is not executable because MS is being executed.

Next, in step S516, the CPU 111 determine whether or not MS has been executed by the post-processing apparatus 500 in response to the bundle of sheets being set in the stack tray 505 by the user. If it is determined that MS has been executed, the CPU 111 advances the processing to step S518. If it is determined that MS has not been executed, the CPU 111 advances the processing to step S517. In step S517, the CPU 111 determines whether or not the MS mode should be canceled in the post-processing apparatus 500. For example, as described above, if the manual stapling mode button 520 has been pressed or if the preset timeout period has elapsed, the CPU 111 determines that the MS mode of the post-processing apparatus 500 should be cancelled, and advances the processing to step S518. On the other hand, the CPU 111 otherwise determines that the MS mode of the post-processing apparatus 500 should not be cancelled, and returns the processing to step S516.

In step S518, the CPU 111 shifts the post-processing apparatus 500 to the AS mode again by cancelling the MS mode of the post-processing apparatus 500, and ends the processing. Note that if the CPU 111 has received the next job (print job), it starts the execution of the next print job.

Note that in the present embodiment, if it becomes apparent that a condition occurs in which control that is different from the control in accordance with the setting in the print job is performed in the post-processing apparatus 500 (“YES” in step S503 or “YES” in step S508), a user instruction is accepted via the operation unit 150. However, the CPU 111 may automatically set the MS mode shifting flag to ON, without accepting a user instruction. Also, the user may be allowed to set in advance whether or not to automatically set the MS mode shifting flag to ON when such a condition has occurred (i.e., whether or not to automatically shift the post-processing apparatus 500 to MS mode when the print job ends).

As described thus far, when a condition occurs in which the post-processing apparatus 500 discharges sheets without executing the post-processing set in the print job, the image forming apparatus 400 according to the present embodiment shifts the post-processing apparatus 500 to the MS mode after the execution of the print job ends. Since the image forming apparatus 400 shifts the post-processing apparatus 500 to the MS mode before starting the execution of a subsequent print job, the user will not be prevented from performing manual stapling by sheets that are discharged by the subsequent print job. That is, after the execution of the print job ends, the user will not be hindered by the subsequent print job, and can use manual stapling without giving a mode shifting instruction in the post-processing apparatus 500. Thus, according to the present embodiment, it is possible to improve the convenience for the user that uses post-processing performed by the post-processing apparatus 500.

### Other Embodiments

Note that the above-described embodiment illustrates an example in which whether or not to shift to the MS mode is selected by displaying the MS mode shifting setting screen 750 in step S504, and whether or not to shift to the MS mode is determined in step S505. However, the present invention is not limited to this example. If it is determined in step S503 that stapling by the post-processing apparatus 500 cannot be executed, the CPU 111 may advance the processing to step S506 without performing the processing of steps S504 and S505.

While the above-described embodiment illustrates an example in which the post-processing apparatus 500 is shifted to the automatic stapling mode or the manual stapling mode, the execution of printing processing in the printer unit 300 is put in the stopped state in step S515. In other words, the mode of the image forming apparatus 400 is changed.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-241269, filed Nov. 21, 2013, which is hereby incorporated by reference herein in its entirety.

What is claimed is:

1. A printing apparatus comprising:
a printing unit configured to print an image on a sheet;
a conveyance unit configured to convey the sheet on which printing has been performed by the printing unit to a post-processing apparatus;
a post-processing unit configured to cause the post-processing apparatus to execute post-processing on the sheet conveyed by the conveyance unit or a sheet set by a user; and
a changing unit configured to change the printing apparatus to a mode that permits execution of the post-processing on a sheet that has been set in the post-processing apparatus by the user, in response to having been unable to execute the post-processing by the post-processing apparatus although the post-processing is set for the sheet conveyed by the conveyance unit.

2. The printing apparatus according to claim 1,
wherein the post-processing by the post-processing apparatus is not executed if a number of sheets on which an image has been printed by the printing unit exceeds a limit of a number of sheets on which the post-processing is executable.

3. The printing apparatus according to claim 2,
wherein the number of sheets on which the post-processing is executable is predetermined based on a type or size of a sheet to be used for a print job.

4. The printing apparatus according to claim 1,
further comprising a selection unit configured to allow the user to select whether or not to change to the mode, in response to having been unable to execute the post-processing by the post-processing apparatus although the post-processing is set for the sheet conveyed by the conveyance unit,
wherein if the selection unit has selected to change to the mode, the changing unit changes the printing apparatus to the mode that permits execution of the post-processing on the sheet that has been set in the post-processing apparatus by the user, in response to having been unable to execute the post-processing by the post-processing apparatus although the post-processing is set for the sheet conveyed by the conveyance unit.

5. The printing apparatus according to claim 1,
wherein the changing unit cancels the mode when execution of the post-processing in the mode by the post-processing apparatus ends.

6. The printing apparatus according to claim 1, wherein the post-processing is stapling.

7. A printing apparatus comprising:
a printing unit configured to print an image on a sheet;
a conveyance unit configured to convey the sheet on which the image is printed by the printing unit to a post-processing apparatus;
a post-processing unit configured to cause the post-processing apparatus to execute post-processing on the sheet conveyed by the conveyance unit; and
a limitation unit configured to limit printing of an image by the printing unit on the sheet conveyed by the conveyance unit, in response to having been unable to execute the post-processing by the post-processing apparatus.

8. The printing apparatus according to claim 7,
wherein the post-processing by the post-processing apparatus is not executed if a number of sheets on which the image is printed by the printing unit exceeds a limit of a number of sheets on which the post-processing is executable.

9. The printing apparatus according to claim 8,
wherein the number of sheets on which the post-processing is executable is predetermined based on a type or size of a sheet to be used for a print job.

10. The printing apparatus according to claim 7,
further comprising a selection unit configured to allow the user to select whether or not to limit printing of an image by the printing unit, in response to having been unable to execute the post-processing by the post-processing apparatus although the post-processing is set for the sheet conveyed by the conveyance unit,
wherein the limitation unit limits printing of an image by the printing unit if the selection unit has selected to limit printing of an image, in response to having been unable to execute the post-processing by the post-processing apparatus although the post-processing is set for the sheet conveyed by the conveyance unit.

11. A control method for controlling a printing apparatus, the method comprising steps of:
printing an image on a sheet;
conveying the sheet on which printing has been performed in the printing step to a post-processing apparatus;
causing the post-processing apparatus to execute post-processing on the sheet conveyed in the conveying step or a sheet set by a user; and
changing the printing apparatus to a mode that permits execution of the post-processing on a sheet that has been set in the post-processing apparatus by the user, in response to having been unable to execute the post-processing by the post-processing apparatus although the post-processing is set for the sheet conveyed in the conveying step.

12. A computer-readable storage medium storing a computer program for causing a computer to execute steps of a control method for controlling a printing apparatus, the method comprising steps of:
printing an image on a sheet;
conveying the sheet on which printing has been performed in the printing step to a post-processing apparatus;
causing the post-processing apparatus to execute post-processing on the sheet conveyed in the conveying step or a sheet set by a user; and
changing the printing apparatus to a mode that permits execution of the post-processing on a sheet that has been set in the post-processing apparatus by the user, in response to having been unable to execute the post-processing by the post-processing apparatus although the post-processing is set for the sheet conveyed in the conveying step.
